(19) United States
(12) Patent Application Publication
(10) Pub. No.: US 2004/0028290 A1
(43) Pub. Date: Feb. 12, 2004

(54) System, method and program product for creating composite images

(76) Inventor: William Gamble, Troy, NY (US)

Correspondence Address: HOFFMAN WARNICK & D'ALESSANDRO, LLC, 3 E-COMM SQUARE, ALBANY, NY, 12207

(21) Appl. No.: 10/633,948

(22) Filed: Aug. 4, 2003

Related U.S. Application Data
(60) Provisional application No. 60/401,366, filed on Aug. 5, 2002.

(51) Int. Cl. G06K 9/36

(52) U.S. Cl. 382/284; 382/296

(57) ABSTRACT

System, method and program product for creating composite images. A layout template is generated that includes one or more composite image templates. Each composite image template includes at least one image area. An image can be associated with each image area to create the composite image. The composite image can be saved as an image file or the like.

### REFERENCE TO PRIOR APPLICATION

This application claims the benefit of co-pending U.S. Provisional Application Serial No. 60/401,366, filed on Aug. 5, 2002.

### BACKGROUND OF THE INVENTION

1. TECHNICAL FIELD

The invention relates to the creation of images, and more specifically to a system, method and program product for generating one or more composite image templates and creating composite images using the composite image templates.

2. BACKGROUND ART

Photo albums are commonly used to present and store photographs. There are many different styles and types of photo album pages. Some photo album pages utilize album mats, which are covers to the photo album page that have cutouts so that a portion of the photograph shows through. A photo album page that has a mat is referred to as a matted album page. Photo album pages where the photograph is mounted directly to the page of the photo album and does not have a mat are referred to as flush album pages. Most commonly, flush album pages contain a single image that is sized to fill up the entire page of the album.

Many professional photographers provide their clients with a photo album containing some, or all of the photographs they were paid to take. Deciding which photographs are to be used in the album, and the placement of the photographs within the pages can be time consuming and tedious task. For example, the placement of photographs is restricted by the mat or flush album page layouts available for a photograph album.

Photo album design software allows photographers to layout a photo album by previewing images in the layout of mats or flush album pages that are available through different album companies. Software of this type aids in designing photo albums, but still restricts the photographer to layouts made available by a particular album company.

A composite image is a single image that is generated by combining all or some of two or more previously distinct images. Photographers can create their own composite image designs for photo album pages by using an image editing program, or the like, and utilizing digital images to create a composite image of one or more images. The composite image can be saved, printed, and used as a single image in a flush photo album page. Creating flush album pages using this method gives the photographer much more design and artistic flexibility, but requires extensive time, effort, knowledge, and use of an image editing application.

Consequently, there exists a need for a system, method and program product that simplifies the procedure for generating a composite image. In particular, there exists a need for a system, method and program product that allows a user to generate one or more composite image templates and use the composite image template(s) to create and store composite images.

### SUMMARY OF THE INVENTION

The invention provides a system, method and program product for creating a composite image. In particular, a user defines a layout template that includes one or more composite image templates. Each composite image template also includes one or more image areas. In order to create the composite image, a user selects a desired composite image template, and associates one or more images with each image area in the composite image template. When creation of the composite image is complete, the composite image can be saved as an image file. The layout template, and each composite image template included therein, can be reused to create any number of composite images.

A first aspect of the invention provides a method of creating a composite image, comprising: providing a composite image template that includes at least one image area; and associating at least one image with the at least one image area; and saving the composite image based on the composite image template and the at least one image.

A second aspect of the invention provides a system for creating a composite image, comprising: an image display system for displaying the composite image, wherein the composite image is based on a composite image template that includes at least one image area; an association system for associating at least one image with the at least one image area; and an image file system for saving the composite image based on the composite image template and the at least one image.

A third aspect of the invention provides a program product stored on a recordable medium for creating a composite image, which when executed comprises: program code for displaying the composite image, wherein the composite image is based on a composite image template that includes at least one image area; program code for associating at least one image with the at least one image area; and program code for saving the composite image based on the composite image template and the at least one image.

A fourth aspect of the invention provides a method of generating a composite image template, the method comprising: adding a first image area to the composite image template; and selecting background attributes of the composite image template.

A fifth aspect of the invention provides a system for generating a composite image template, the system comprising: a template display system for displaying the composite image template; a background system for selecting background attributes of the composite image template; and an image area system for adding an image area to the composite image template.

A sixth aspect of the invention provides a program product stored on a recordable medium for generating a composite image template, which when executed comprises: program code for displaying the composite image template; program code for selecting background attributes of the composite image template; and program code for adding an image area to the composite image template.

The illustrative aspects of the invention are designed to solve the problems herein described and other problems not discussed, which are discoverable by a skilled artisan.

### BRIEF DESCRIPTION OF THE DRAWINGS

These and other features of the invention will be more readily understood from the following detailed description of the various aspects of the invention taken in conjunction with the accompanying drawings in which:

FIG. 1 shows an illustrative system for creating a composite image according to one embodiment of the invention;

FIG. 2 shows a more detailed view of the layout definition system shown in FIG. 1;

FIG. 3 shows data flow between the various systems shown in FIG. 1;

FIG. 4 shows an illustrative user interface for generating a layout template according to another embodiment of the invention; and

FIG. 5 shows an illustrative user interface for creating a composite image according to still another embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As discussed above, the invention provides a system, method and program product for creating a composite image. In particular, a user defines a layout template that includes one or more composite image templates. Each composite image template also includes one or more image areas. In order to create the composite image, a user selects a desired composite image template, and associates one or more images with each image area in the composite image template. When creation of the composite image is complete, the composite image can be saved as an image file. The layout template, and each composite image template included therein, can be reused to create any number of composite images.

It is understood that while the invention is described as generating a layout, the generation of a layout having only a single composite image can be considered as equivalent to generating a composite image. Similarly, generating a layout template having only a single composite image template can be considered as equivalent to generating a composite image template.

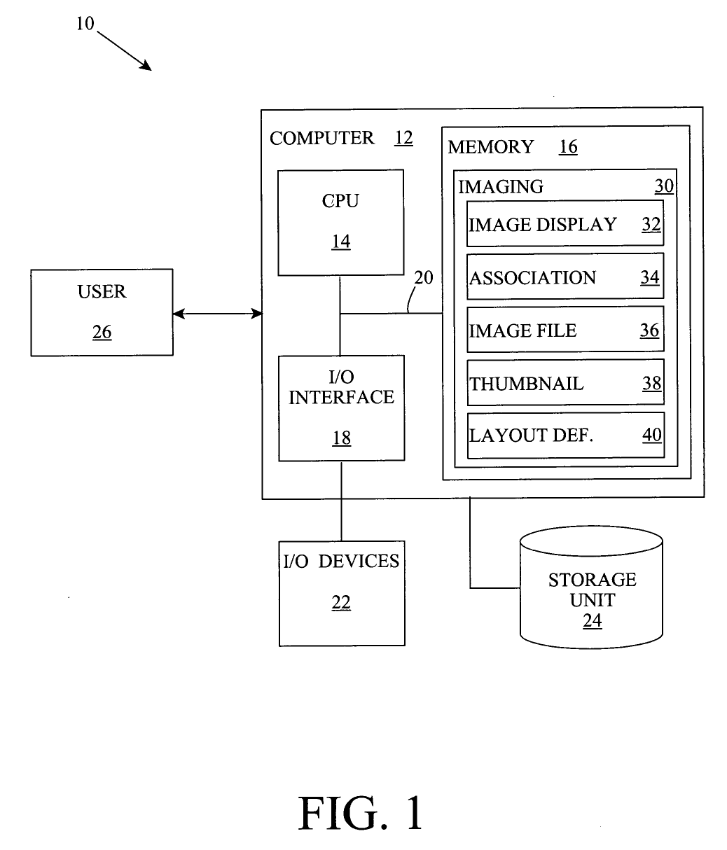

Referring now to FIG. 1, a system 10 for creating a composite image is shown. System 10 includes a computer system 12 that generally comprises a central processing unit (CPU) 14, memory 16, input/output (I/O) interface 18, bus 20, I/O devices 22 and storage unit 24. User 26 communicates with computer system 12 using one or more I/O devices 22 or by communicating with a user system (not shown) which in turn communicates with computer system 12. To this extent, it is understood that computer system 12 comprises any type of device capable of accepting input, providing output, and/or communicating with another device.

Computer system 12 can comprise any general purpose or specific-use system utilizing standard operating system software, which is designed to drive the operation of the particular hardware and which is compatible with other system components and I/O controllers. CPU 14 may comprise a single processing unit, multiple processing units capable of parallel operation, or be distributed across one or more processing units in one or more locations, e.g., on a network. Memory 16 may comprise any known type of data storage and/or transmission media, including magnetic media, optical media, random access memory (RAM), read-only memory (ROM), a data cache, a data object, etc. Similarly, storage unit 24 may provide storage for information necessary to carry out the present invention as described herein. As such, storage unit 24 may include one or more storage devices, such as a magnetic disk drive or an optical disk drive. Moreover, similar to CPU 14, memory 16 and/or storage unit 24 may reside at a single physical location, comprising one or more types of data storage, or be distributed across a network in a plurality of physical systems in various forms.

I/O interface 18 may comprise any system for exchanging information to/from one or more I/O devices 22. I/O devices 22 may comprise any known type of external device, including speakers, a CRT, LED screen, handheld device, keyboard, mouse, voice recognition system, speech output system, printer, monitor/display, facsimile, pager, etc. Bus 20 provides a communication link between each of the components in computer system 12 and likewise may comprise any known type of transmission link, including electrical, optical, wireless, etc. In addition, although not shown, additional components, such as cache memory, communication systems, system software, etc., may be incorporated into computer system 12.

Shown in memory 16 as computer program code is imaging system 30. Imaging system 30 creates a layout that includes one or more composite images by using a layout template that includes one or more composite image templates and one or more images. In order to do this, imaging system 30 is shown including an image display system 32, an association system 34, an image file system 36, a thumbnail system 38, and a layout definition system 40. Operation of each of these systems is described further below. It is understood, however, that the systems configuration shown is only illustrative of numerous possible embodiments. As a result, the functions provided by each of the systems could be represented by different systems, divided into additional systems, merged into fewer systems, and/or implemented as a system separate from imaging system 30. For example, layout definition system 40 could be implemented separately from the remaining systems.

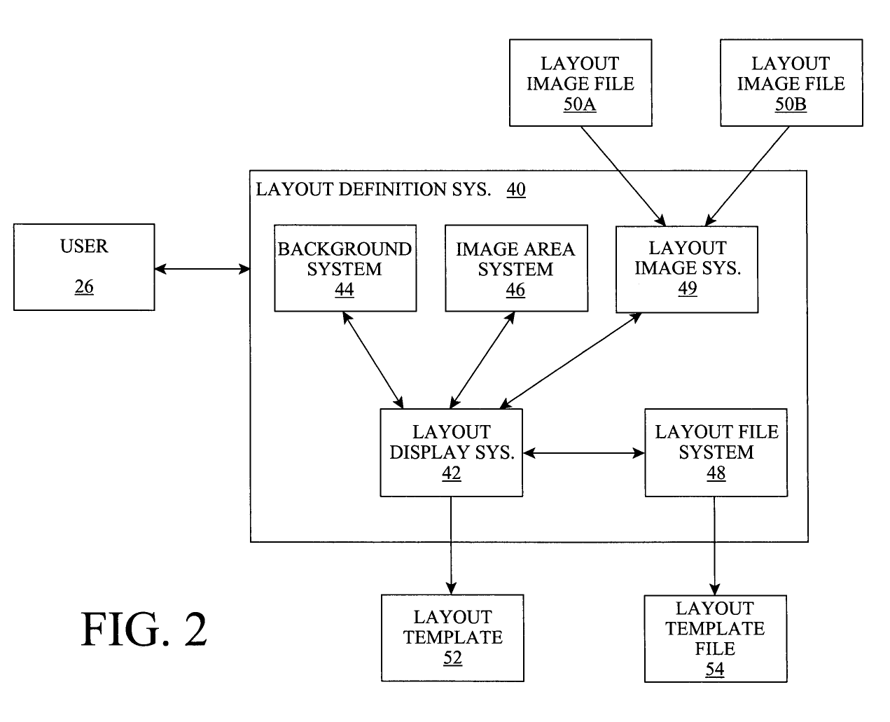

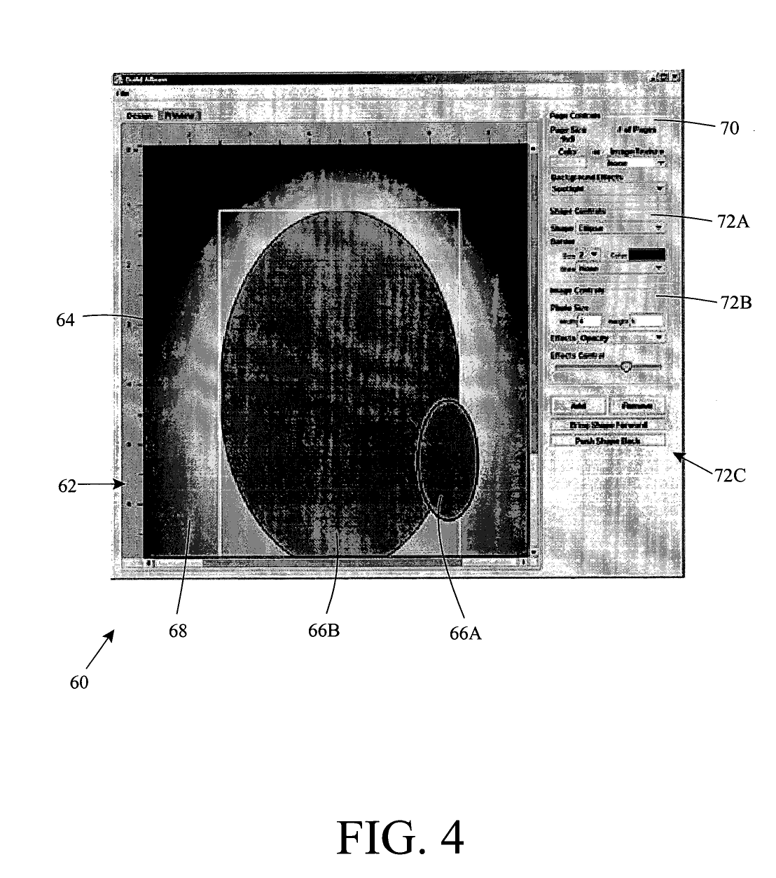

As discussed above, a layout can be created that includes one or more composite images. Each composite image is created using a composite image template that includes at least one image area. The composite image template(s) can be generated using layout definition system 40. Layout definition system 40 will be described in more detail with reference to FIGS. 2 and 4. FIG. 2 shows a more detailed view of layout definition system 40 according to one embodiment of the invention, and FIG. 4 shows an illustrative user interface 60 that allows user 26 to generate layout template 52. Layout definition system 40 is shown including a layout display system 42, a background system 44, an image area system 46, a layout file system 48, and a layout image system 49. Operation of layout definition system 40 will now be discussed with reference to the various systems.

Layout display system 42 displays layout template 52 to user 26 to assist user 26 in generating layout template 52. For example, user interface 60 includes a layout area 62 that displays a selected composite image template 64. When user 26 seeks to define a new layout template 52, default attributes can initially be used for layout template 52. For example, a default name, number of composite image templates 64, width, height, background, and/or image area can be initially used for layout template 52. The initial attributes can be preset based on commonly selected attributes, based on the attributes used for a previous layout template 52, etc. To this extent, a set of default attributes can always be used, or can be configurable by user 26. Additionally, layout definition system 40 can allow user 26 to select one or more of the attributes of layout template 52 prior to its being displayed by layout display system 42. In any event, as user 26 modifies layout template 52, layout display system 42 displays the updated layout template 52.

As previously discussed, layout template 52 includes one or more composite image templates 64. Each composite image template 64 includes one or more image areas 66A-B. Frequently, the one or more image areas 66A-B do not fill the entire area of the composite image template 64. As a result, some background 68 will also be included in composite image template 64. User 26 can select background attributes of composite image template 64 using background system 44. For example, background system 44 can display various background controls 70 for allowing user 26 to select one or more background attributes. Background attributes can include, among other things, a color, a pattern, an image, an effect (e.g., spotlight), etc. When user 26 changes a background attribute using background system 44, the change can be immediately shown in the displayed composite image template 64 by layout display system 42 (e.g., in layout area 62). User 26 can independently or simultaneously alter background attributes for each composite image template 64 included in layout template 52. For example, user 26 may want each composite image template 64 to have the same background color, but only some of the composite image templates 64 to have a spotlight effect.

User 26 can manage (i.e., add, modify, delete) the image area(s) 66A-B in each composite image template 64 using image area system 46. For example, user 26 can select to add a new image area 66A-B to a currently selected composite image template 64 in layout template 52. User 26 can select various image area attributes such as a height and width, and a shape (i.e., rectangle, ellipse, trapezoid, irregular, etc.) prior to adding the image area 66A-B to composite image template 64. Additional image attributes such as a border presence, border size, border color, border style, and any effects (e.g., clipping or skewing) can also be selected by user 26 using image area system 46. Once added, user 26 can modify one or more of the image attributes, adjust the location of image areas 66A-B within composite image template 64, delete an image area 66A-B, etc. Further, when more than one image area is placed in a composite image template, a priority four each image area can be selected to determine which image is displayed above another image when the image areas overlap. As shown in FIG. 4, layout display system 42 can visually indicate a selected image area 66B using any indicator (e.g., white box surrounding image area 66B). Image area system 46 can display various image area controls 72A-C that allow user 26 to alter one or more of the image attributes of the selected image area 66B. In one embodiment, image area system 46 separates the image area controls 72A-C into three groups. One group of image area controls 72A allows user 26 to select the shape and border attributes of image area 66B. A second group of image area controls 72B allows user 26 to select the size and effects for image area 66B, and a third group of image area controls 72C allows user 26 to add, remove, and change the display order of a selected image area 66B.

User 26 can use layout file system 48 to save layout template 52 as a layout template file 54. This allows user 26 to later modify layout template 52 and/or use layout template 52 to create a custom layout. Layout template file 54 can comprise any type of object for storing and retrieving the layout template 52 using, for example, a software product. To this extent, layout template file 54 could comprise an electronic file, or one or more entries stored in a database located on, for example, storage unit 24 (FIG. 1). When layout template file 54 comprises an electronic file, an open standard such as Extensible Markup Language (XML) or the like can be used to store the data.

One or more layout image files 50A-B can be associated with layout template 52 using layout image system 49. Layout image files 50A-B can comprise a set of image files that can be selected by user 26 and associated with one or more image areas 66A-B in the layout template 52. User 26 can select layout image files 50A-B by, for example, selecting one or more directories in which the image files are located. Alternatively, each layout image file 50A-B can be chosen by user 26 to be included as a layout image file 50A-B. Still further, the directory in which the layout template file 54 is located can be used. User 26 can also associate an image represented by a layout image file 50A-B with an image area 66A-B as part of a composite image template 64.

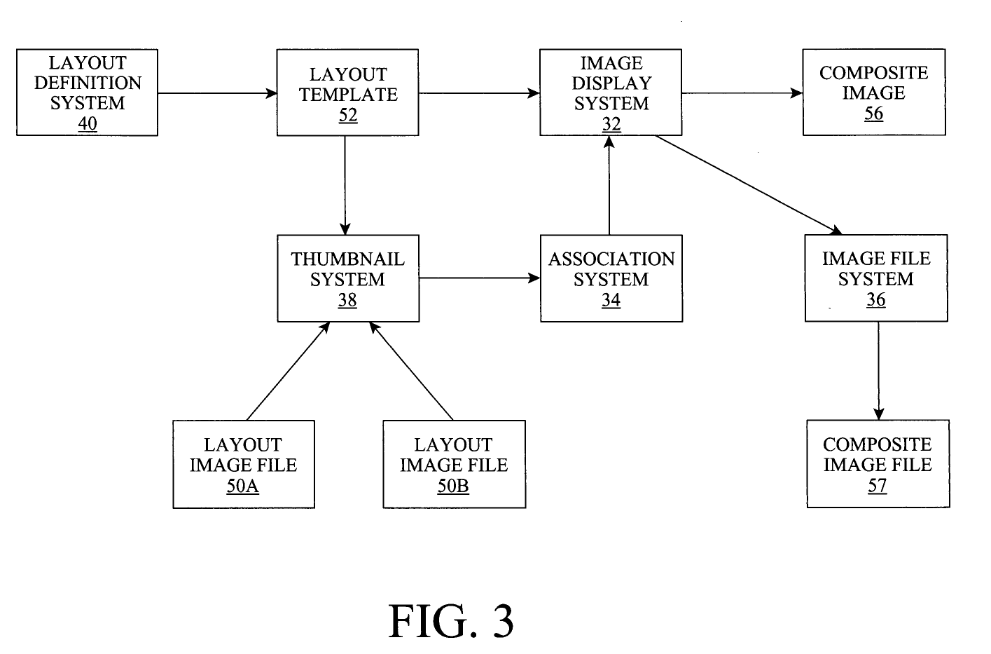

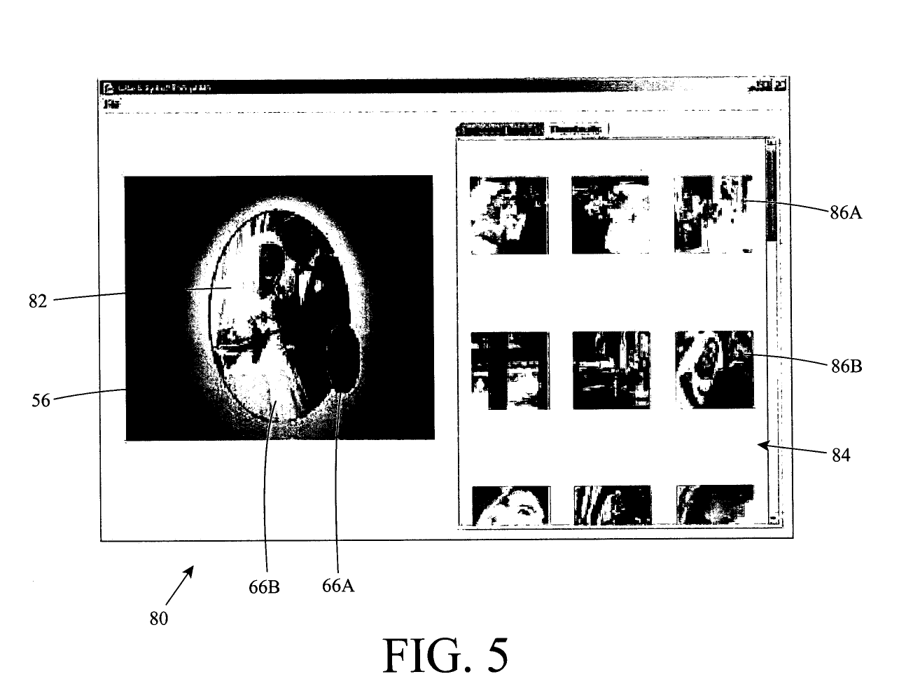

Once layout template 52 is defined, user 26 can use layout template 52 to create a custom layout. The custom layout includes one or more composite images 56. An illustrative system for creating the custom layout will be discussed with reference to the remaining systems shown in FIG. 1, and to FIGS. 3 and 5 in particular. FIG. 3 shows an illustrative data flow between the various systems, and FIG. 5 shows an illustrative user interface 80 for allowing user 26 (FIG. 1) to create one or more composite images 56. As previously discussed, layout definition system 40 generates a layout template 52. Image display system 32 uses layout template 52 to display a composite image 56 being created based on one of the composite image templates 64 (FIG. 4) in layout template 52. In particular, image display system 32 reads the image attributes for a particular composite image template 64 and displays it to user 26 as composite image 56. When an image 82 is associated with an image area 66B in composite image 56, image display system 32 displays image 82 within the area defined by image area 66B. When user 26 has not associated an image with an image area 66A, image display system 32 can display a particular color (e.g., grey), pattern, etc. in the space defined by image area 66A.

Thumbnail system 38 can also use layout template 52 to display images stored in one or more layout image files 50A-B that are associated with layout template 52. In particular, thumbnail system 38 can read a list of layout image files 50A-B associated with layout template 52 and/or can read all image files stored in a directory that is associated with layout template 52. Further, user 26 can use thumbnail system 38 to add layout image files 50A-B to layout template 52 and/or remove layout image files 50A-B from layout template 52. In any event, thumbnail system 38 can display images 86A-B represented by each layout image file 50A-B to user 26 in an image display area 84 of user interface 80. In order to present several images 86A-B simultaneously to user 26, each image 86A-B can be compressed to a set width and height (i.e., a thumbnail) for previewing by user 26. Further, when layout template 52 includes more than one composite image template, thumbnail system 38 can also display thumbnails of the composite images 56 based on each composite image template in image display area 84 to allow user 26 to select a desired composite image template.

User 26 (FIG. 1) can use association system 34 to associate an image 82 with an image area 66B in a composite image 56. For example, user 26 can “drag and drop” an image 86A-B displayed by thumbnail system 38 over an area defined by a desired image area 66A-B. Once image 82 has been associated with image area 66B, image display system 32 can display image 82 within the area defined by image area 66B. Image display system 32 can adjust image 82 to conform to the associated image area 66B. For example, image display system 32 can clip image 82 to conform to the shape of the image area 66B. Additionally, image display system 32 may rotate, stretch, and/or skew image 82. User 26 can further adjust the location of image 82 within image area 66B so that a particular feature of image 82 is displayed in a desired location within image area 66B.

Image file system 36 can save the composite image 56 as a composite image file 57. Any file format can be used by image file system 36 to represent composite image 56 in composite image file 57. For example, the composite image template attributes, and associated image(s) attributes can be stored so that composite image 56 can be further modified using imaging system 40 (FIG. 1). Alternatively, composite image file 57 can comprise an image file that stores image data using a standard image format such as bitmap, JPEG File Interchange Format, Graphics Interchange Format, etc. Each composite image 56 can be stored in a separate composite image file 57 (e.g., an image file) or stored in a single composite image file 57 along with other composite images 56. When stored in separate files, user 26 (FIG. 1) can select a directory that will store all the composite image files 57 using, for example, image file system 36.

The composite image(s) created by the invention can be used, for example, as page(s) in a flush photo album, as a single image in a matted album page, as a single framed image, etc. While shown and discussed with respect to a particular embodiment, it is clear that numerous variations are possible. For example, user 26 (FIG. 1) may only be capable of using layout template(s) 52 provided by a third party, or only be able to use and modify existing layout templates 52. To this extent, it is understood that different users may use applications that implement limited functions of the invention. For example, a photographer may create a layout template 52 that includes various composite image templates 64 (FIG. 4) using one application, a customer may create composite images 56 using the photographer's layout template 52, and a third party may generate a photo album using composite images 56. Further, one or more attributes of layout template 52 could be modified using image display system 32 rather than layout definition system 40. For example, user 26 could be allowed to move an image area 66A-B while viewing a composite image template 64.

It is understood that all or portions of the present invention can be realized in or carried out with the assistance of hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of creating a composite image, comprising:
providing a composite image template that includes at least one image area; and
associating at least one image with the at least one image area; and
saving the composite image based on the composite image template and the at least one image.

2. The method of claim 1, further comprising generating a composite image template file that describes the composite image template.

3. The method of claim 2, wherein the generating step includes adding a first image area to the composite image template.

4. The method of claim 3, wherein the generating step further includes adding a second image area to the composite image template.

5. The method of claim 4, wherein the second image area and the first image area overlap.

6. The method of claim 2, wherein the generating step includes selecting background attributes of the composite image template.

7. The method of claim 2, wherein the generating step includes adding at least one template image file to the composite image template.

8. The method of claim 1, further comprising adjusting the at least one image to conform to the associated image area.

9. The method of claim 8, wherein the adjusting step comprises at least one of: clipping, rotating, stretching, and skewing the at least one image.

10. The method of claim 1, wherein the saved composite image comprises an image file.

11. A system for creating a composite image, comprising:
an image display system for displaying the composite image, wherein the composite image is based on a composite image template that includes at least one image area;
an association system for associating at least one image with the at least one image area; and
an image file system for saving the composite image based on the composite image template and the at least one image.

12. The system of claim 11, further comprising a template definition system for generating a composite image template file that describes the composite image template, wherein the image display system uses the composite image template file.

13. The system of claim 12, wherein the template definition system includes:
a template display system for displaying the composite image template;
a background system for selecting background attributes of the composite image template;
an image area system for adding an image area to the composite image template; and
a template file system for saving the composite image template as a composite image template file.

14. The system of claim 13, wherein the template definition system further includes a template image system for associating a template image file with the composite image template.

15. The system of claim 11, wherein the association system displays the associated at least one image within the at least one image area.

16. The system of claim 11, further comprising a thumbnail system for displaying a template image that is associated with the composite image template.

17. A program product stored on a recordable medium for creating a composite image, which when executed comprises:
program code for displaying the composite image, wherein the composite image is based on a composite image template that includes at least one image area;
program code for associating at least one image with the at least one image area; and
program code for saving the composite image based on the composite image template and the at least one image.

18. The program product of claim 17, further comprising program code for generating a composite image template file that describes the composite image template, wherein the image display system uses the composite image template file.

19. The program product of claim 18, wherein the program code for generating includes:
program code for displaying the composite image template;
program code for selecting background attributes of the composite image template;
program code for adding an image area to the composite image template;
program code for associating a template image file with the composite image template; and
program code for saving the composite image template as a composite image template file.

20. The program product of claim 18, further comprising program code for displaying a template image that is associated with the composite image template.
